(19) United States
(12) Patent Application Publication
(10) Pub. No.: US 2018/0314548 A1
(43) Pub. Date: Nov. 1, 2018

(54) WORK ITEM MANAGEMENT IN CONTENT MANAGEMENT SYSTEMS

(71) Applicant: Microsoft Technology Licensing, LLC, Redmond, WA (US)

(72) Inventors: Burra Gopal, Bellevue, WA (US); Krishna Raghava Mulubagilu Panduranga Rao, Bellevue, WA (US); Darell Macatangay, Redmond, WA (US); Patrick Kabore, Redmond, WA (US); Ramanathan Somasundaram, Bothell, WA (US); Constantin Stanciu, Redmond, WA (US); Sean Squires, Edmonds, WA (US)

(21) Appl. No.: 15/499,395

(22) Filed: Apr. 27, 2017

(51) Int. Cl. G06F 9/48; H04L 29/08

(52) U.S. Cl. CPC G06F 9/4881; H04L 67/10

(57) ABSTRACT

Techniques for work item management in distributed computing systems are disclosed herein. In one embodiment, a method can include receiving a user request from a user to initiate a provisioning process for a site to be hosted in the distributed computing system. In response to the received user request from the user, a work item containing one or more tasks to be performed in the provisioning process can be generated. The generated work item can then be enqueued in a work item queue with a future time that is later than a current time at which the generated work item is enqueued. Subsequently, the enqueued work item can be dequeued from the work item queue at a time earlier than the future time of the enqueued task to trigger performance of the one or more tasks contained in the work item related to the provisioning process of the site.

### BACKGROUND

Content management systems are distributed computing systems that support management of digital content by users. Common features of content management systems include web-based publishing, format management, history editing and version control, indexing, searching, and retrieval. To provide such features, content management systems can utilize a collection of remote servers interconnected by one or more computer networks to provide computing, storage, communications, or other functionalities. During operation, one or more remote servers can cooperate to provide a distributed computing environment that facilitates activation and/or execution of various applications or features in order to provide desired functionalities of content management.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In certain content management systems, content and associated content management functionalities can be grouped into network accessible containers. One example container is a SharePoint® site, which is a web-addressable location to store, organize, share, and access content via, for example, an intranet or the Internet. A SharePoint® site can have features representing various functionalities and behaviors that can be activated or deactivated by site administrators. Such features can be used to expose content management functionalities as well as allowing users of the site to obtain data from external sources.

A user can create a site by providing to a content management system user credentials and a list of desired features of content management. Upon verification, the content management system can provision for the requested site before access to the site can be permitted. Such site provisioning can include various work items or tasks such as placing a configuration file of the site in a content database, activating the requested list of desired features, appropriately securing the site by configuring access control, and providing access to the site over a computer network. For instance, providing access to the site can include specifying IP addresses, IP Gateways, virtual networks, Domain Name System (“DNS”) parameters, or other network parameters to suitable computer networks and storage resources. In another example, activating features can include first selecting one or more servers from a pool of available servers in datacenters, computing clusters, or other computing facilities. Images or copies of operating systems, device drivers, middleware, applications, or other suitable software components can then be located and provided to the selected servers. The software components can then be configured to generate a boot image for the selected servers. The servers can then start one or more virtual machines to load and execute the software components to provide the requested features.

Servers in content management systems may be categorized as frontend servers and backend servers based on types of tasks performed by the individual servers. For example, frontend servers can include those configured to perform tasks at least one aspect of which involves user interaction (referred to herein as “interactive tasks”). One example frontend server can be a web server configured to provide a user an software interface (e.g., a user portal) that receives a user request to provision a site or other suitable user input. In contrast, backend servers can include those configured to perform automated tasks that do not involve user interaction (referred to herein as “automated tasks”). Examples of automated tasks can include virus scanning, performing software updates, content indexing, etc.

In certain content management systems, work items related to provisioning a site or other user requests may be stored and tracked in a work item queue common to and accessible by both the frontend servers and backend servers. Frontend servers can enqueue work items and both frontend and backend servers can dequeue work items from the work item queue for executing corresponding tasks. The inventors have recognized that dequeuing work items by the backend servers can sometimes cause significant delays to a provisioning process of a site. For example, once a frontend server enqueues a work item in the work item queue for a provisioning process, a backend server can immediately dequeue the enqueued work item from the work item queue and prevent any other frontend servers to dequeue the same work item. The backend server, however, may be unable to promptly perform the tasks related to the dequeued work item related to the provisioning process because the backend server is typically configured and optimized for bulk processing and not for interactive operations, and thus resulting in significant delays to the provisioning process. On the other hand, the frontend servers are typically configured and optimized for interactive operations. The frontend servers, however, can fail more often than the backend servers due to fluctuations and/or randomness in load. As such, a backup to the frontend servers may be desirable.

Several embodiments of the disclosed technology can address at least some of the foregoing drawbacks by implementing a work item management scheme in which work items are preferentially processed by frontend servers while backend servers act as backup for the frontend servers. In certain embodiments, a frontend server can receive a user request for provisioning a site (or performing other suitable operations). In response, the frontend server can generate one or more work items with corresponding tasks and enqueue the work items in the work item queue with a future date/time relative to a current date/time. For example, the work items can be enqueued with a date/time that is five, ten, twenty, or thirty minutes later than a current date/time. In certain embodiments, the future date/time can be set based on an average time to perform the tasks for provisioning the site by the frontend server according to historical data. In other embodiments, the future date/time can be set based on an expected time to perform the tasks for provisioning the site by the frontend server. In further embodiments, the future date/time can be set by an administrator or other suitable entities.

Thus, when the work items are enqueued in the work item queue, no backend server would attempt to dequeue the enqueued work items because of the future date/time. The frontend server (or one or more other frontend servers) can then dequeue the work items from the work item queue before the future date/time and initiate performance of the corresponding tasks for provisioning the site. In certain situations when the frontend server fails, the enqueued work item would not be dequeued from the work item queue. In such situations, a backend server can then dequeue the enqueued work items after the future date/time. As such, the backend server can be a backup for the frontend server for performance of the tasks for provisioning the site.

Several embodiments of the disclosed technology can provide fast site provisioning in content management systems. By enqueuing work items with future date/time and immediately dequeue the work items with frontend servers, chances of dequeuing the work items by backend servers may be reduced or even prevented. As such, delays to the provisioning process due to processing delays at the backend servers may be reduced or avoided. Thus, the requested site can be quickly provisioned for access by users to ensure suitable user experience.

### BRIEF DESCRIPTION OF THE DRAWINGS

FIG. 1 is a schematic diagram of a distributed computing system implementing work item management in accordance with embodiments of the disclosed technology.

FIGS. 2A-2D are schematic diagrams illustrating certain hardware/software components of the distributed computing system in FIG. 1 during certain stages of managing work items during a provisioning process.

FIGS. 3A-3D are flowcharts illustrating various aspects of processes of managing work items in a distributed computing system in accordance with embodiments of the disclosed technology.

FIG. 4 is a computing device suitable for certain components of the computing system in FIG. 1.

### DETAILED DESCRIPTION

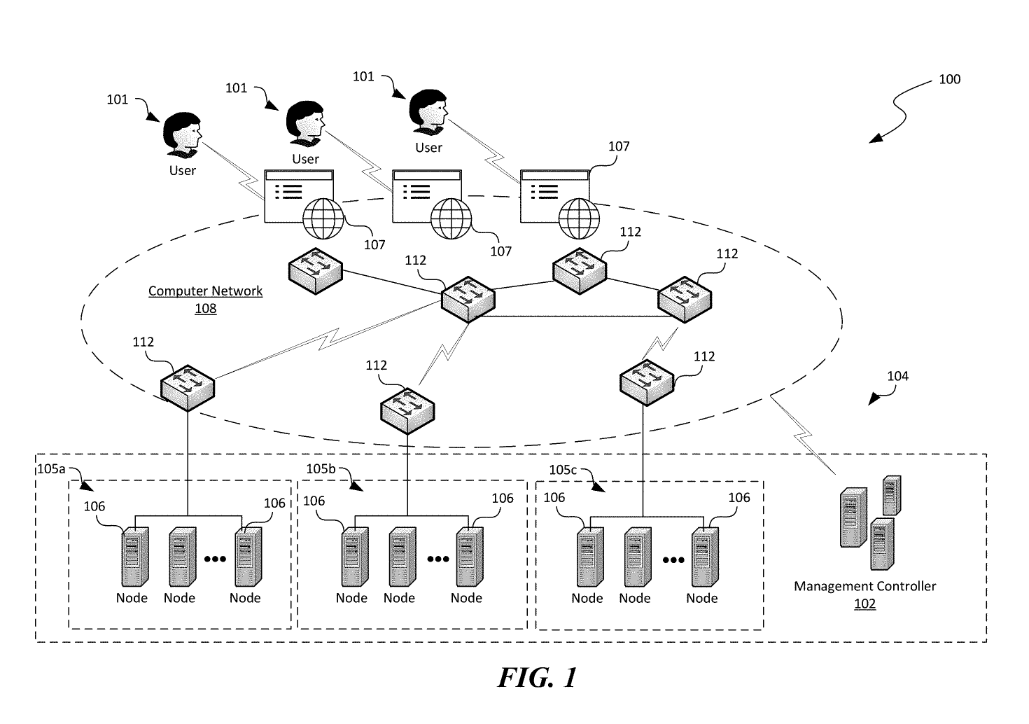

Certain embodiments of computing systems, devices, components, modules, routines, and processes for managing work items in distributed computing systems are described below. In the following description, specific details of components are included to provide a thorough understanding of certain embodiments of the disclosed technology. A person skilled in the relevant art can also understand that the disclosed technology may have additional embodiments or may be practiced without several of the details of the embodiments described below with reference to FIGS. 1-4.

As used herein, the term “computing cluster” generally refers to a computer system having a plurality of network devices that interconnect multiple servers or nodes to one another or to external networks (e.g., the Internet). One example of a computing cluster is one or more racks each holding multiple servers in a cloud computing datacenter (or portions thereof) configured to provide cloud services. One or more computing clusters can be interconnected to form a “computing fabric.” The term “network device” generally refers to a network communications component. Example network devices include routers, switches, hubs, bridges, load balancers, security gateways, or firewalls. A “node” generally refers to a computing device configured to implement one or more virtual machines, virtual routers, virtual gateways, or other suitable virtualized computing components. For example, a node can include a computing server having a hypervisor configured to support one or more virtual machines.

Also used herein, the term “cloud service” generally refers to computing resources provided over a computer network such as the Internet. Common examples of cloud services include software as a service (“SaaS”), platform as a service (“PaaS”), and infrastructure as a service (“IaaS”). SaaS is a software distribution technique in which software applications are hosted by a cloud service provider in, for instance, datacenters, and accessed by users over a computer network. PaaS generally refers to delivery of operating systems and associated services over the computer network without requiring downloads or installation. IaaS generally refers to outsourcing equipment used to support storage, hardware, servers, network devices, or other components, all of which are made accessible over a computer network.

Further, as used herein, the term a “site” generally refers to a network accessible container having content and associated features of content management configured by a site owner. One example container is a SharePoint® site, which is a Web-addressable location to store, organize, share, and access content via, for example, an intranet or the Internet. “Features” of a site are computer programs having codes that extend the functionality of the site in some ways. Features can be authored using HTML, JavaScript, CSS, or other web technologies. At a basic level, a feature of a site provides a user a way to create, inspect, monitor, delete, and configure content of the site, cloud assets, or other suitable resources. For example, a feature on a site can include a display of a list of news, documents, links, or other suitable types of content of the site. In another example, a feature can also include a computer program configured to retrieve data (e.g., weather forecast) from an external source and display/update the retrieved data on the site.

Also used herein, the term “site provisioning” or “provisioning” generally refers to a set of preparatory actions for providing a network accessible site requested by a user in a distributed computing system. The predatory actions can be grouped into one or more work items or tasks. For example, such work items can include placing a configuration file of the site in a content database, activating the requested list of desired features, appropriately securing the site, and providing access to the site over a computer network. In another example, work items can also include selecting one or more servers from a pool of available servers in datacenters, computing clusters, or other computing facilities. Work items can also include locating and providing access to images of operating systems, device drivers, middleware, applications, or other suitable software components related to the cloud services. The images of the software components can then be configured to generate a boot image for the selected servers. Work items can also include assigning IP addresses, IP Gateways, virtual networks, DNS servers, or other network parameters to the selected servers and/or executed software components. The servers can then load and execute the software components in order to provide features of the site.

Further used herein, the term “frontend server” generally refers to a server configured to perform tasks at least one aspect of which involves user interaction. For example, a frontend server can be a web server configured to provide a user an software interface (e.g., a user portal) that receives a user request to provision a site or other suitable user input. In contrast, a “backend server” is configured to perform automated tasks that do not involve user interaction. Example automated tasks can include virus scanning, performing software updates, content indexing, etc. Though servers may be categorized as frontend and backend servers, such servers can be generally similar in hardware components or certain software components (e.g., an operating system).

In certain computing systems, work items related to provisioning a site or other user requests may be stored and tracked in a work item queue. Frontend servers can enqueue work items and both frontend and backend servers can dequeue work items from the work item queue for executing corresponding tasks. However, dequeuing work items by the backend servers can sometimes cause significant delays to a provisioning process or other processes to corresponding user requested computing services because the backend servers are typically not designed or configured for interactive operations. For example, a backend server can dequeue the work item from the work item queue but may be unable to promptly perform the tasks related to the dequeued work item due to processing or other delays at the backend server, and thus resulting in significant delays to the provisioning process.

Several embodiments of the disclosed technology can address at least some of the foregoing drawbacks by implementing a work item management scheme in which work items are preferentially processed by frontend servers while backend servers act as backup for the frontend servers. In certain embodiments, a frontend server can enqueue one or more work items in the work item queue with a future date/time relative to a current time. For example, the work items can be enqueued with a date/time that is five, ten, twenty, or thirty minutes in the future relative to a current system date/time at the frontend server. Thus, when the work items are enqueued in the work item queue, no backend server would attempt to dequeue the enqueued work items because of the future date/time. The frontend server can then dequeue the work items from the work item queue before the future date/time is reached and initiate performance of the corresponding tasks for provisioning the site. As such, chances of dequeuing the work items by backend servers may be reduced or even prevented, as described in more detail below with reference to FIGS. 1-4.

Even though the disclosed technology is described below in the context of provisioning a site in response to a user request in a content management system, in other embodiments, embodiments of the disclosed technology can also be implemented in the context of providing other suitable computing services in response to user requests. Example computing services can include content storage, content retrieval, content searching, content sharing, or other suitable computing services.

FIG. 1 is a schematic diagram illustrating a distributed computing system 100 implementing work item management in accordance with embodiments of the disclosed technology. In certain embodiments, the distributed computing system 100 can be a content management system. In other embodiments, the distributed computing system 100 can also be other suitable types of computing system. As shown in FIG. 1, the distributed computing system 100 can include a computer network 108 interconnecting a plurality of users 101 and a computing fabric 104. Even though particular components of the distributed computing system 100 are shown in FIG. 1, in other embodiments, the distributed computing system 100 can also include additional and/or different constituents. For example, the distributed computing system 100 can include additional computing fabrics, network storage devices, utility infrastructures, and/or other suitable components.

As shown in FIG. 1, the computer network 108 can include one or more network devices 112 that interconnect the users 101 and components of the computing fabric 104. Examples of the network devices 112 can include routers, switches, firewalls, load balancers, or other suitable network components. Even though particular connection scheme is shown in FIG. 1 for illustration purposes, in other embodiments, the network devices 112 can be operatively coupled in a hierarchical, flat, “mesh,” or other suitable topologies.

As shown in FIG. 1, the computing fabric 104 can include a management controller 102 and a plurality of nodes 106 operatively coupled to one another by the network devices 112. In certain embodiments, the nodes 106 can individually include a processor, a physical server, or a blade containing several physical servers. In other embodiments, the nodes 106 can also include a virtual server or several virtual servers. The nodes 106 can be organized into racks, availability zones, groups, sets, computing clusters, or other suitable divisions. For example, in the illustrated embodiment, the nodes 106 are grouped into three computing clusters 105 (shown individually as first, second, and third computing clusters 105a-105c, respectively), which are operatively coupled to corresponding network devices 112 in the computer network 108. Even though three computing clusters 105 are shown in FIG. 1 for illustration purposes, in other embodiments, the computing fabric 104 can include one, two, eight, sixteen, or any other suitable numbers of computing clusters 105 with similar or different components and/or configurations.

The management controller 102 can be configured to monitor, control, or otherwise manage operations of the nodes 106 in the computing clusters 105. For example, in certain embodiments, the management controller 102 can include a fabric controller configured to manage processing, storage, communications, or other suitable types of hardware resources in the computing clusters 105 for hosting cloud services. In other embodiments, the management controller 102 can also include a datacenter controller, application delivery controller, or other suitable types of controller. In the illustrated embodiment, the management controller 102 is shown as being separate from the computing clusters 105. In other embodiments, the management controller 102 can include one or more nodes 106 in the computing clusters 105. In further embodiments, the management controller 102 can include software services hosted on one or more of the nodes 106 in the computing clusters 105.

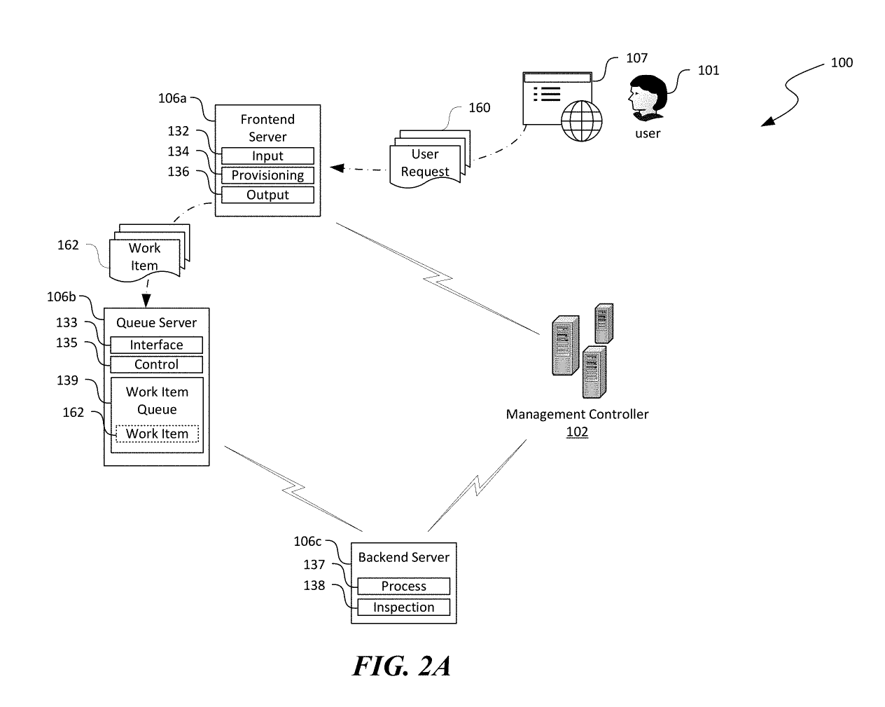

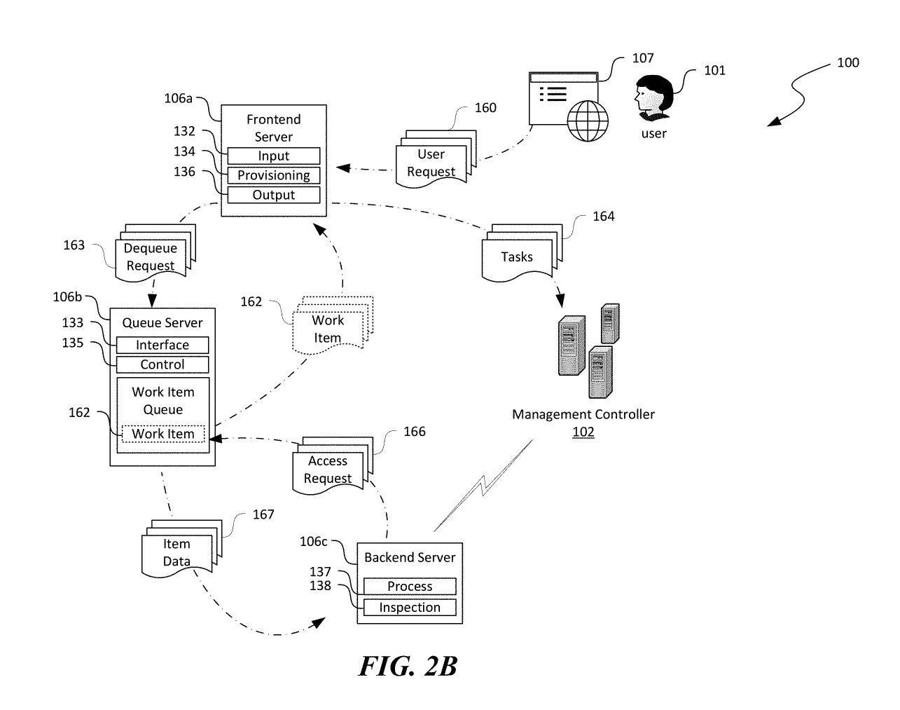

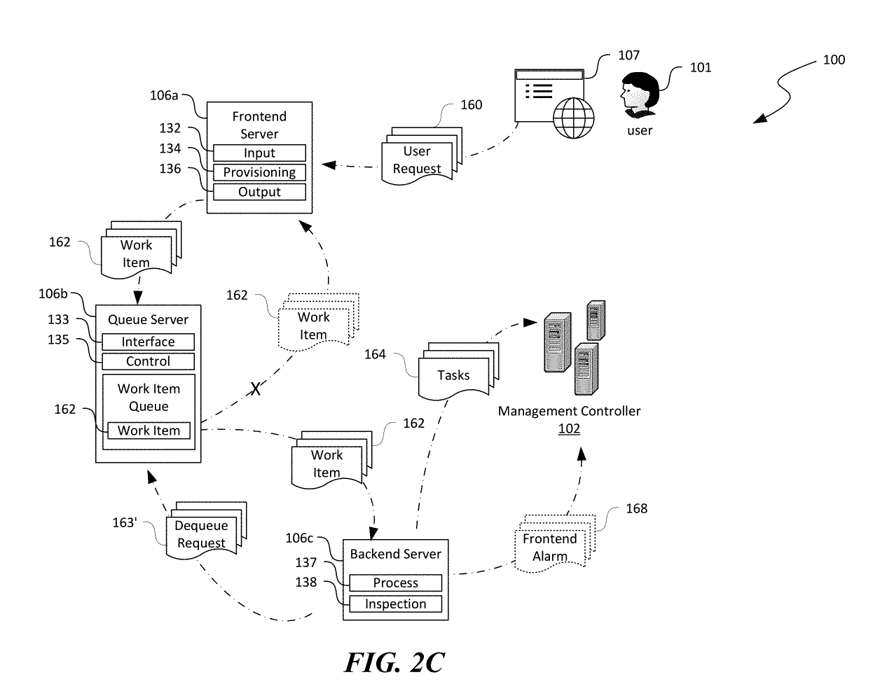

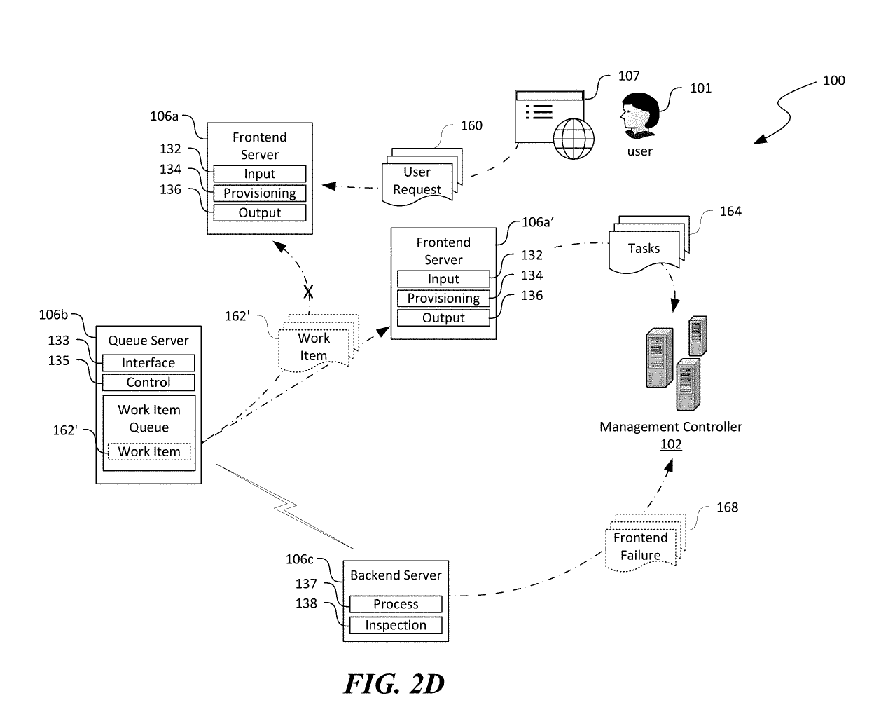

As discussed in more detail below with reference to FIGS. 2A-2D, the nodes 106 in the computing clusters 105 may be categorized as frontend servers 106a and backend servers 106c (shown in FIGS. 2A-2D). As illustrated in FIG. 1, the frontend servers 106a can include web servers configured to provide a user portal 107 with corresponding webpages to the users 101. The user portals 107 can individually include functionalities that allow the users 101 to manage, access, or otherwise interact with various computing services provided by the computing fabric 104. The backend servers 106c may be configured to perform virus scanning, performing software updates, content indexing, or other suitable maintenance tasks in the computing fabric 104.

FIGS. 2A-2D are schematic diagrams illustrating certain hardware/software components of the distributed computing system 100 in FIG. 1 during certain stages of a site provisioning process. In FIGS. 2A-2D, certain components of the distributed computing system 100 are omitted for clarity. For example, only one frontend server 106a, one queue server 106b, and one backend server 106c are shown in FIGS. 2A-2D for illustration purposes. In other embodiments, distributed computing system 100 can include any suitable numbers of frontend, queue, or backend servers 106a-106c. In further embodiments, the queue server 106b may be omitted, and similar functionalities may be provided by the frontend server 106a, the backend server 106c, or another suitable database server (not shown).

In addition, in FIGS. 2A-2D and in other Figures herein, individual software components, objects, classes, modules, and routines may be a computer program, procedure, or process written as source code in C, C++, C#, Java, and/or other suitable programming languages. A component may include, without limitation, one or more modules, objects, classes, routines, properties, processes, threads, executables, libraries, or other components. Components may be in source or binary form. Components may include aspects of source code before compilation (e.g., classes, properties, procedures, routines), compiled binary units (e.g., libraries, executables), or artifacts instantiated and used at runtime (e.g., objects, processes, threads). In certain embodiments, the various components and modules described below can be implemented with actors. In other embodiments, generation of the application and/or related services can also be implemented using monolithic applications, multi-tiered applications, or other suitable components.

Components within a system can take different forms within the system. As one example, a system comprising a first component, a second component and a third component can, without limitation, encompass a system that has the first component being a property in source code, the second component being a binary compiled library, and the third component being a thread created at runtime. The computer program, procedure, or process may be compiled into object, intermediate, or machine code and presented for execution by one or more processors of a personal computer, a network server, a laptop computer, a smartphone, and/or other suitable computing devices. Equally, components may include hardware circuitry.

A person of ordinary skill in the art would recognize that hardware may be considered fossilized software, and software may be considered liquefied hardware. As just one example, software instructions in a component may be burned to a Programmable Logic Array circuit, or may be designed as a hardware circuit with appropriate integrated circuits. Equally, hardware may be emulated by software. Various implementations of source, intermediate, and/or object code and associated data may be stored in a computer memory that includes read-only memory, random-access memory, magnetic disk storage media, optical storage media, flash memory devices, and/or other suitable computer readable storage media excluding propagated signals.

As shown in FIG. 2A, the user 101 can access the user portal 107 provided by a client device (e.g., a desktop computer, not shown) for transmitting a user request 160 requesting a site to be hosted in the distributed computing system 100 of FIG. 1. The user request 160 can include a name, a template, a list of one or more specified features, a location, or other suitable information related to the site. In other embodiments, the user 101 can also provide display configurations, credentials, execution configurations, subscription information, or other suitable data via the user portal 107. In further embodiments, a developer, administrator, or other suitable types of entity can provide the configurations, and/or other suitable information in lieu of or in addition to the user 101.

Also shown in FIG. 2A, the frontend server 106a can include an input component 132, a provisioning component 134, and an output component 136 operatively coupled to one another. The input component 132 can be configured to receive the user request 160 from the user 101 via the user portal 107. The input component 132 can identify the user request 160 as a request for a site based on information included in the user request 160 and forward the received user request 160 to the provisioning component 134 for further processing.

The provisioning component 134 can be configured to generate one or more work items 162 for provisioning the site requested by the user 101. In one embodiment, the provisioning component 134 can generate a single work item 162 that contains multiple tasks corresponding to discrete stages of a provisioning process for the site. For example, the work item 162 can be identified with information of the user 101 and contain multiple tasks corresponding to, for example, placing a configuration file of the site in a content database, activating a list of desired features for the site, appropriately securing the site by configuring access control, and providing access to the site over a computer network. In other embodiments, the provisioning component 134 can generate multiple work items individually containing one or more tasks of the provisioning process for the site. For example, one or more of the foregoing example tasks may be included in a distinct work item 162.

As shown in FIG. 2A, the provisioning component 134 can also be configured to cause the created work item 162 be enqueued in a work item queue 139 provided by the queue server 106b with a future date/time that in the future relative to a system date/time at the frontend server 106a, the queue server 106b, a date/time of the computer network 108 (FIG. 1), or other suitable system date/time. For example, the work item 162 can be enqueued with a date/time that is five, ten, twenty, or thirty minutes in the future relative to a current date/time. In certain embodiments, the future date/time can be set based on an average time to perform the tasks for executing the work item 162 by the frontend server 106a according to historical data. In other embodiments, the future date/time can be set based on an expected time to perform the tasks of the work item 162 for provisioning the site by the frontend server 106a. In further embodiments, the future date/time can be set by an administrator or other suitable entities.

The queue server 106b can include an interface component 133 and a control component 135 operatively coupled to each other. The interface component 133 can be configured to interact with the frontend server 106a, the backend server 106b, the management controller 102, or others suitable components of the distributed computing system 100. The control component 135 can be configured to maintain the work item queue 139 and provide suitable functionalities for facilitating operations of the work item queue 139. For instance, the control component 135 can be configured to enqueue and dequeue work item 162 to/from the work item queue 139. In another example, the control component 135 can also be configured to allow the frontend and backend servers 106a and 106c to inspect various items in the work item queue 139. In further examples, the control component 135 can be configured to provide sorting, filtering, or other suitable operations in the work item queue 139.

As shown in FIG. 2A, upon receiving the work item 162 from the frontend server 106a, the interface component 133 can forward the work item 162 to the control component 135 for further processing. In certain embodiments, the control component 135 of the queue server 106b can be configured to select the future date/time and enqueue the work item 162 with the future date/time represented by a time stamp in the work item queue 139. In other embodiments, the provisioning component 134 of the frontend server 106a can be configured to select the future date/time and transmit the selected future date/time as a time stamp to the queue server 106b. In further embodiments, the future date/time may be selected by the management controller 102 or other suitable components in the distributed computing system 100. In FIG. 2A and other figures herein, the enqueued work item 162 with the future date/time is shown in phantom lines for clarity.

As shown in FIG. 2A, the backend server 106c can include a process component 137 and an inspection component 138. The process component 137 can be configured to perform virus scanning, performing software updates, content indexing, or other suitable maintenance operations in the distributed computing system 100. The inspection component 138 can be configured to inspect any work items 162 in the work item queue 139 and instruct the process component 137 to perform suitable operations, as discussed in more detail below with reference to FIG. 2C.

As shown in FIG. 2B, in accordance with several embodiments of the disclosed technology, the provisioning component 134 of the frontend server 106a can be configured to cause the work item 162 enqueued in the work item queue 139 with the future date/time be dequeued from the work item queue 139 before the future date/time is reached. For example, if the future date/time has a value of Apr. 20, 2017, at 12:00 PM, the frontend server 106a can transmit a dequeue request 163 before the foregoing date/time, for example, at a current time of Apr. 20, 2017, at 11:55 AM to dequeue the work item 162. In response, the control component 135 at the queue server 106b can dequeue the work item 162 before the future date/time is reached and transmit the work item 162 to the frontend server 106a for further processing. Upon receiving the work item 162, the provisioning component 134 can be configured to perform or cause to be performed by, for example, transmitting the tasks 164 included in the work item 162 to the management controller 102.

In accordance with several embodiments of the disclosed technology, the backend server 106c would not request the queue server 106b to dequeue the work item 162 before the future date/time is reached. For example, as shown in FIG. 2B, the inspection component 138 of the backend server 106c can be configured to request inspection of the work item 162 in the work item queue 139 by transmitting an access request 166 to the queue server 106b. In response, the control component 135 can provide item data 167 including the time stamp of the work item 162 to the backend server 106c. The inspection component 138 can then determine whether the time stamp of the work item 162 represents a date/time that is equal to or earlier than a system date/time, for example, at the backend server 106c. In response to determining that the time stamp of the work item 162 represents a date/time that is in the future relative to the system date/time, the inspection component 138 is configured to maintain the work item 162 in the work item queue 139 without requesting the queue server 106b to dequeue the work item 162. As such, several embodiments of the disclosed technology can prevent the backend server 106c to dequeue the work item 162 before the future date/time is reached.

In certain situations, the frontend server 106a may not be able to cause the work item 162 be dequeued before the future date/time is reached. For example, the frontend server 106a may have failed, may lost communication with the queue server 106b, or may be subject to other conditions rendering the frontend server 106a inoperable. In such situation, the work item 162 previously enqueued with the future date/time can stay in the work item queue 139 until the future date/time is reached or passed. For instance, in the previous example, if the current time is current time of Apr. 20, 2017, at 12:05 PM, and the work item 162 (shown with solid lines for clarity) is still in the work item queue 139, the inspection component 138 can determine that the time stamp of the work item 162 represents a date/time that is not in the future relative to the system date/time and instruct the process component 137 to request dequeuing the work item 162 by transmitting a dequeue request 163′ to the queue server 106b. In response, the control component 135 of the queue server 106b can dequeue the work item 162 and transmit the dequeued work item 162 to the backend server 106c for further processing. In turn, upon receiving the work item 162, the process component 137 of the backend server 106c can be configured to perform or cause to be performed by, for example, transmitting the tasks 164 included in the work item 162 to the management controller 102. As such, the backend server 106c can act as a backup for the frontend server 106a for performance of the tasks 164 for provisioning the site requested by the user 101.

Optionally, as shown in FIG. 2C, the inspection component 138 can also be configured to transmit a frontend alarm 168 to the management controller 102 in response to determining that the time stamp of the work item 162 represents a date/time that is not in the future relative to the system date/time. In response, the management controller 102 may assign another frontend server 106a′ to process other work items 162′ (only one is shown for illustration purposes) that have a time stamp representing a date/time that is in the future of the current system date/time, as shown in FIG. 2D. In other embodiments, multiple frontend servers 106a (not shown) can be configured to cause different work items 162 be dequeued from the work item queue 139. In such embodiments, the backend server 106c can act as a backup for any or all of the frontend servers 106a.

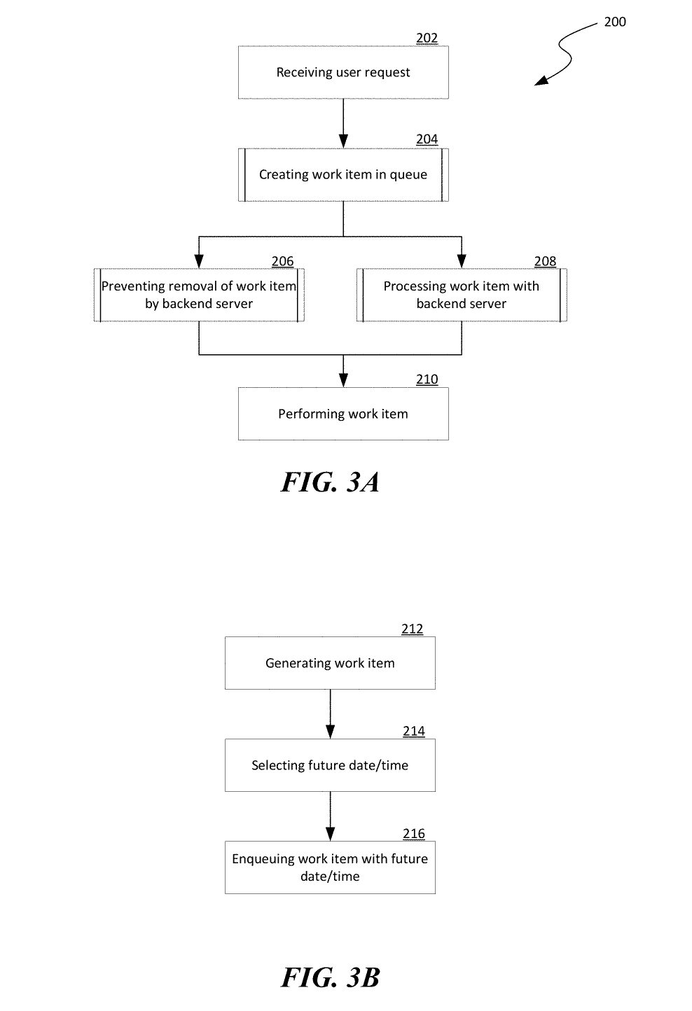

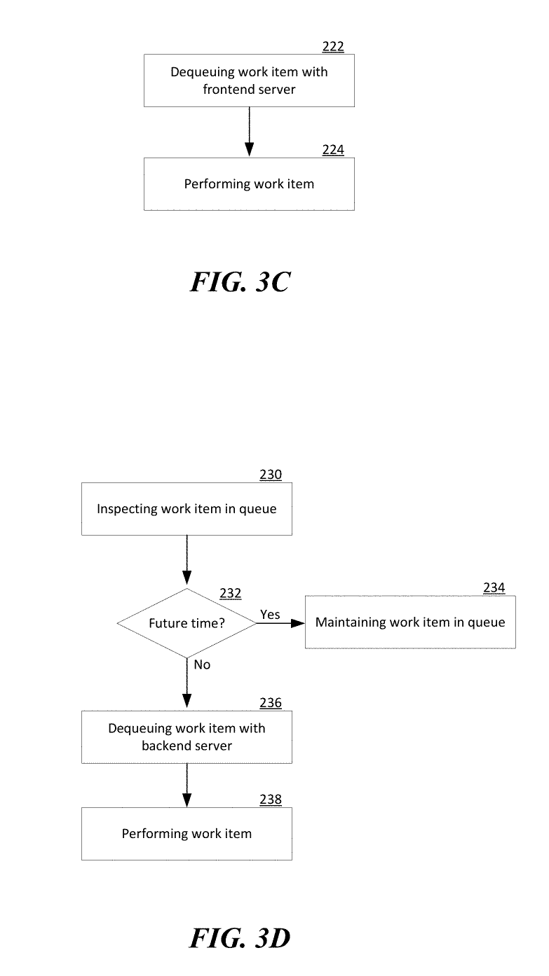

FIGS. 3A-3D are flowcharts illustrating various aspects of processes of managing work items in a distributed computing system in accordance with embodiments of the disclosed technology. Even though aspects of the processes are described below with reference to the distributed computing system 100 of FIGS. 1 and 2A-2D, in other embodiments, the processes can also be implemented in other computing systems with different or additional components.

As shown in FIG. 3A, the process 200 can include receiving a user request for a computing service such as initiating site provisioning for a site at stage 202. In certain embodiments, the user request can include a list of features for the site, for example, specified by a user via a dropdown menu or other suitable input fields. The process 200 can then include creating one or more work items for provisioning the site in a work item queue at stage 204. Example operations of creating the work item in the work item queue are described in more detail with respect to FIG. 3B.

The process 200 can then include preventing removal of the work item by a backend server from the work item queue at stage 206. In certain embodiments, preventing removal of the work item can include enqueuing the work item with a future date/time and dequeuing the work item with a frontend server before the future date/time is reached, as described above with reference to FIGS. 2A-2D. In other embodiments, preventing removal of the work item by the backend server can include locking the enqueued work item in the work item queue for a period of time after enqueuing the work item and only allowing frontend servers to dequeue the work item. In further embodiments, preventing removal of the work item by the backend server can also include other suitable techniques. Example operations of dequeuing the work item from the work item queue with a frontend server are described in more detail with respect to FIG. 3C.

In certain situations, the work item may stay in the work item queue for a period because the frontend server has failed or otherwise inoperable. As such, the process 200 can then include processing the work item with backend server if a determined period has passed at stage 208. Example operations of processing the work item queue with a backend server are described in more detail with respect to FIG. 3D. The process 200 can then 9include performing one of more tasks identified in the work item in order to provide a computing service requested by the user.

FIG. 3B is a flowchart illustrating example operations for creating a work item in a work item queue. As shown in FIG. 3B, the operations can include generating a work item based on a received user request at stage 212. The work item can include one, two, or any suitable number of tasks to be performed in order to provide the requested computing service. The operations can then include selecting a future date/time for the work item at stage 214. In certain embodiments, the future date/time is selected by adding a time interval to a current system date/time. The time interval can be based on an average time to perform the tasks by a frontend server according to historical data, an expected time to perform the tasks by the frontend server, or a time interval set by an administrator or other suitable entities. In other embodiments, the future date/time can be selected in other suitable manners. The operations can then include enqueuing the work item in a work item queue with a time stamp representing the selected future date/time at stage 216.

FIG. 3C is a flowchart illustrating example operations of dequeuing the work item from the work item queue with a frontend server. As shown in FIG. 3C, the operations can include dequeuing a work item with a frontend server from a work item queue before a future date/time associated with the work item is reached. In certain embodiments, dequeuing the work item can be performed by the frontend server in conjunction with enqueuing the work item in the work item queue. In other embodiments, dequeuing the work item can be performed by the frontend server in other suitable manners before the future date/time of the work item is reached. The operations can then include performing tasks identified in the work item at stage 224.

FIG. 3D is a flowchart illustrating example operations of processing a work item with a backend server. As shown in FIG. 3D, the operations can include inspecting a work item in a work item queue at stage 230. The operations can then include a decision stage 232 to determine whether a date/time represented by a time stamp of the work item is in the future relative to a current system date/time. In response to determining that the date/time represented by the time stamp of the work item is in the future relative to the current system date/time, the operations include maintaining the work item in the work item queue without dequeuing the work item at stage 234. Otherwise, the operations include dequeuing the work item with the backend server at stage 236 and performing tasks identified by the work item at stage 238.

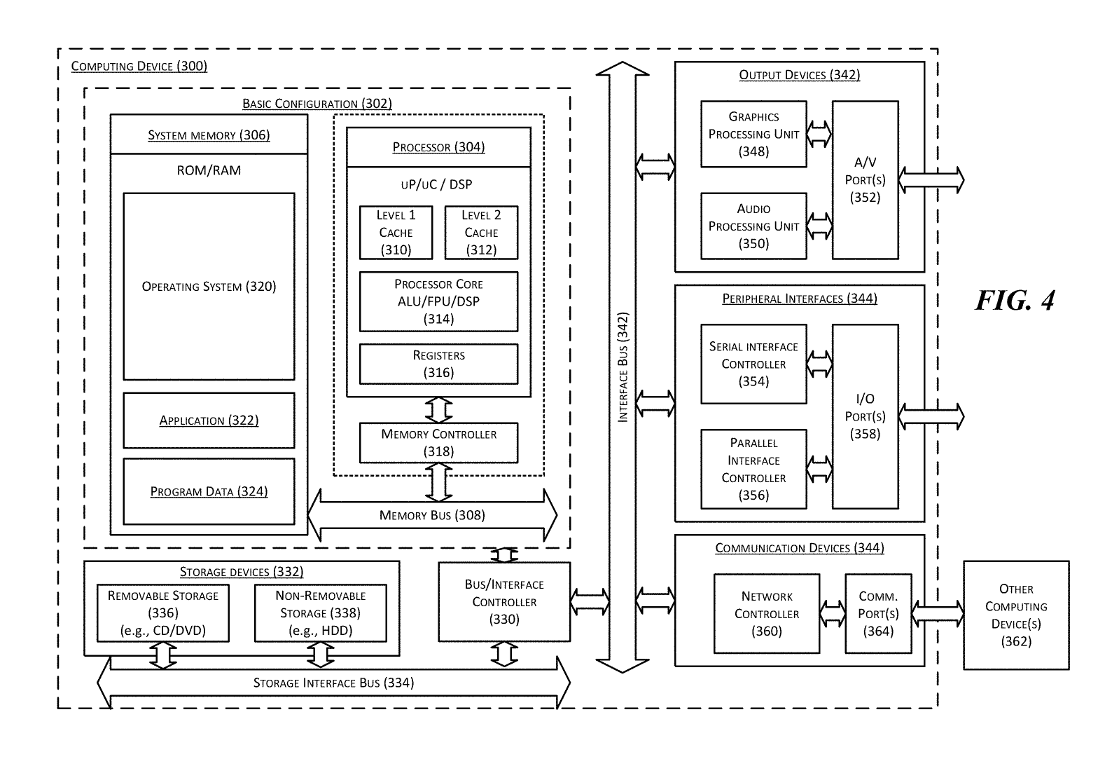

FIG. 4 is a computing device 300 suitable for certain components of the distributed computing system 100 in FIG. 1. For example, the computing device 300 can be suitable for the nodes 106, the management controller 102, or the provisioning controller 110 of FIG. 1. In a very basic configuration 302, the computing device 300 can include one or more processors 304 and a system memory 306. A memory bus 308 can be used for communicating between processor 304 and system memory 306.

Depending on the desired configuration, the processor 304 can be of any type including but not limited to a microprocessor (μP), a microcontroller (μC), a digital signal processor (DSP), or any combination thereof. The processor 304 can include one more levels of caching, such as a level-one cache 310 and a level-two cache 312, a processor core 314, and registers 316. An example processor core 314 can include an arithmetic logic unit (ALU), a floating point unit (FPU), a digital signal processing core (DSP Core), or any combination thereof. An example memory controller 318 can also be used with processor 304, or in some implementations, memory controller 318 can be an internal part of processor 304.

Depending on the desired configuration, the system memory 306 can be of any type including but not limited to volatile memory (such as RAM), non-volatile memory (such as ROM, flash memory, etc.) or any combination thereof. The system memory 306 can include an operating system 320, one or more applications 322, and program data 324. This described basic configuration 302 is illustrated in FIG. 4 by those components within the inner dashed line.

The computing device 300 can have additional features or functionality, and additional interfaces to facilitate communications between basic configuration 302 and any other devices and interfaces. For example, a bus/interface controller 330 can be used to facilitate communications between the basic configuration 302 and one or more data storage devices 332 via a storage interface bus 334. The data storage devices 332 can be removable storage devices 336, non-removable storage devices 338, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data. The term “computer readable storage media” or “computer readable storage device” excludes propagated or other types of signals and communication media.

The system memory 306, removable storage devices 336, and non-removable storage devices 338 are examples of computer readable storage media. Computer readable storage media include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by computing device 300. Any such computer readable storage media can be a part of computing device 300. The term “computer readable storage medium” excludes propagated signals and communication media.

The computing device 300 can also include an interface bus 340 for facilitating communication from various interface devices (e.g., output devices 342, peripheral interfaces 344, and communication devices 346) to the basic configuration 302 via bus/interface controller 330. Example output devices 342 include a graphics processing unit 348 and an audio processing unit 350, which can be configured to communicate to various external devices such as a display or speakers via one or more A/V ports 352. Example peripheral interfaces 344 include a serial interface controller 354 or a parallel interface controller 356, which can be configured to communicate with external devices such as input devices (e.g., keyboard, mouse, pen, voice input device, touch input device, etc.) or other peripheral devices (e.g., printer, scanner, etc.) via one or more I/O ports 358. An example communication device 346 includes a network controller 360, which can be arranged to facilitate communications with one or more other computing devices 362 over a network communication link via one or more communication ports 364.

The network communication link can be one example of a communication media. Communication media can typically be embodied by computer readable instructions, data structures, program modules, or other data in a modulated data signal, such as a carrier wave or other transport mechanism, and can include any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), microwave, infrared (IR) and other wireless media. The term computer readable media as used herein can include both storage media and communication media.

The computing device 300 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 300 can also be implemented as a personal computer including both laptop computer and non-laptop computer configurations.

From the foregoing, it will be appreciated that specific embodiments of the disclosure have been described herein for purposes of illustration, but that various modifications may be made without deviating from the disclosure. In addition, many of the elements of one embodiment may be combined with other embodiments in addition to or in lieu of the elements of the other embodiments. Accordingly, the technology is not limited except as by the appended claims.

I/We claim:

1. A method of work item management in a distributed computing system having multiple servers organized as frontend servers and backend servers, the method comprising:
receiving, at a frontend server, a user request from a user to initiate a provisioning process for a site to be hosted on one or more servers in the distributed computing system, the frontend server being configured to perform tasks at least one aspect of which involves user interaction;
in response to the received user request from the user,
generating a task related to the provisioning process for the site; and
enqueuing the generated task in a work item queue with a future time that is later than a current time at which the generated task is enqueued; and
when the frontend server is operational, preventing the enqueued task from being dequeued from the work item queue by a backend server configured to perform tasks that do not involve user interaction via:
dequeuing, with the frontend server, the task from the work item queue at a time earlier than the future time of the enqueued task; and
performing, with the frontend server, the task dequeued from the work item queue, thereby avoiding delays caused by the backend server to the provisioning process of the site.

2. The method of claim 1, further comprising:
when the frontend server is not operational,
dequeuing, with the backend server, the task from the work item queue at a time equal or later than the future time of the enqueued task; and
performing, with the backend server, the task dequeued from the work item queue, thereby providing backup for processing the enqueued task to the frontend server.

3. The method of claim 1 wherein receiving the user request includes:
providing, with the frontend server, a user portal to the user; and
receiving, via the provided user portal, the user request from the user to initiate the provisioning process for the site.

4. The method of claim 1 wherein generating the task includes generating one or more of:
storing a configuration file of the site in a content database hosted in the distributed computing system;
specifying one or more of an IP address, an IP Gateway, a virtual network, or a Domain Name System (“DNS”) server for the site; or
configuring access control to the site.

5. The method of claim 1, further comprising selecting the future time based on one or more of:
an average time to perform the task by the frontend server according to historical data;
an expected time to perform the task by the frontend server; or
an input time by an administrator.

6. The method of claim 1 wherein dequeuing the task from the work item queue includes performing, with the frontend server, dequeuing the task from the work item queue in conjunction with enqueuing the task in the work item queue.

7. The method of claim 1 wherein dequeuing the task from the work item queue includes performing, with the frontend server, dequeuing the task from the work item queue at a preset time that is later than the current time at which the task is enqueued but earlier than the future time of the enqueued task.

8. The method of claim 1 wherein avoiding delays caused by the backend server includes avoiding delays caused by the backend server performing one or more of virus scanning, software update, or content indexing.

9. A server in a distributed computing system having multiple servers organized as frontend and backend servers, the server comprising:
a processor; and
a memory operatively coupled to the processor, the memory containing instructions executable by the process to cause the server to:
receive a user request from a user to initiate a provisioning process for a site to be hosted in the distributed computing system; and
in response to the received user request from the user,
generate a work item related to the provisioning process for the site, the work item containing one or more tasks to be performed in the provisioning process;
request to enqueue the generated work item in a work item queue hosted in the distributed computing system with a future time that is later than a current time at which the generated work item is enqueued; and
request to dequeue the enqueued work item from the work item queue at a time earlier than the future time of the enqueued task to trigger performance of the one or more tasks contained in the work item related to the provisioning process of the site.

10. The server of claim 9 wherein the memory contains additional instructions executable by the processor to cause the server to:
provide, via a computer network, a user portal to the user; and
receive, via the provided user portal, the user request from the user to initiate the provisioning process for the site.

11. The server of claim 9 wherein the one or more tasks include:
storing a configuration file of the site in a content database hosted in the distributed computing system;
specifying one or more of an IP address, an IP Gateway, a virtual network, or a Domain Name System (“DNS”) server for the site; or
configuring access control to the site.

12. The server of claim 9 wherein the memory contains additional instructions executable by the processor to cause the server to select the future time based on one or more of:
an average time to perform the task by the frontend server according to historical data;
an expected time to perform the task by the frontend server; or
an input time by an administrator.

13. The server of claim 9 wherein to request to dequeue the work item from the work item queue includes to request to dequeue the work item from the work item queue in conjunction with requesting to enqueue the work item in the work item queue.

14. The server of claim 9 wherein to request to dequeue the work item from the work item queue includes to dequeue the work item from the work item queue at a preset time that is later than the current time at which the task is enqueued but earlier than the future time of the enqueued work item.

15. The server of claim 9 wherein to request to dequeue the enqueued work item from the work item queue includes to request to dequeue the enqueued work item from the work item queue at a time earlier than the future time of the enqueued work item to prevent the enqueued work item from being dequeued by a backend server configured to perform one or more of virus scanning, software update, or content indexing.

16. A method of work item management in a distributed computing system having multiple servers organized as frontend servers configured to perform tasks at least one aspect of which involves user interaction and backend servers configured to perform tasks that do not involve user interaction, the method comprising:
inspecting, with a backend server, a work item contained in a work item queue hosted in the distributed computing system, the work item having a time stamp representing a time set by a frontend server when the frontend server enqueued the work item in the work item queue, the work item containing one or more tasks to be performed in a provisioning process for a site to be hosted in the distributed computing system as requested by a user;
determining, with the backend server, whether the time represented in the time stamp of the work item is in the future relative to a current system time at the backend server; and
in response to determining that the time represented in the time stamp of the work item is in the future relative to the current system time at the backend server, maintaining the work item in the work item queue without dequeuing the work item from the work item queue.

17. The method of claim 16, further comprising:
in response to determining that the time represented in the time stamp of the work item is not in the future relative to the current system time at the backend server,
dequeuing, with the backend server, the work item from the work item queue; and
performing, with the backend server, the tasks contained in the dequeued work item to execute the provisioning process for the requested site.

18. The method of claim 17, further comprising in response to determining that the time represented in the time stamp of the work item is not in the future relative to the current system time at the backend server, indicating that the frontend server is presumed to be failed.

19. The method of claim 16 wherein the time represented in the time stamp of the work item is set by the frontend server to be in the future of a current system time at the frontend server.

20. The method of claim 16 wherein the time represented in the time stamp of the work item is set by the frontend server to be a future time relative to a current system time at the frontend server, and wherein the future time is one of:
an average time to perform the task by the frontend server according to historical data;
an expected time to perform the task by the frontend server; or
an input time by an administrator.
